(19) United States
(12) Patent Application Publication
(10) Pub. No.: US 2016/0358253 A1
(43) Pub. Date: Dec. 8, 2016

(54) ELECTRONIC CURRENCY MANAGEMENT METHOD AND ELECTRONIC CURRENCY SYSTEM

(71) Applicants: DiQi, Inc, Apia (WS); WIFIRE OPEN NETWORK GROUP LIMITED, HONG KONG (HK)

(72) Inventors: Shih-Wei Liao, Taipei City (TW); Che-Jui Chang, Taipei City (TW); Chi-Ning Chou, Taichung City (TW)

(21) Appl. No.: 14/874,483

(22) Filed: Oct. 5, 2015

(30) Foreign Application Priority Data
Jun. 5, 2015 (CN) 201510305609.4

(51) Int. Cl. G06Q 40/04; G06F 17/30

(52) U.S. Cl. CPC G06Q 40/04; G06F 17/30949

(57) ABSTRACT

An electronic currency management method and an electronic currency system, adapted to a blockchain-based electronic currency network having a plurality of node apparatuses, are provided, where the node apparatuses include a first node apparatus. The electronic currency management method includes the following steps. First, consecutive preceding blocks in the blockchain are obtained by the first node apparatus. Next, the number of times that the first node apparatus in the electronic currency network has been elected as a block verifier of the preceding blocks is determined by the first node apparatus, and a difficulty level of the first node apparatus being elected as a block verifier of a next block is adjusted by the first node apparatus according to the elected times.

### CROSS-REFERENCE TO RELATED APPLICATION

This application claims the priority benefit of Chinese application serial no. 201510305609.4, filed on Jun. 5, 2015. The entirety of the above-mentioned patent application is hereby incorporated by reference herein and made a part of this specification.

### TECHNICAL FIELD

The disclosure generally relates to an electronic currency management method and an electronic currency system, in particular, to an electronic currency management method and an electronic currency system able to dynamically adjust a difficulty level of each apparatus being elected as a block verifier.

### BACKGROUND

### Description of Related Art

As the internet has been popularized, electronic currency for trading over the internet is thereby created. In a distributed electronic currency system, Bitcoin has been in existence as an electronic currency for the longest term due to its high security, high stability, high value, a larger number of participants and transactions. The Bitcoin is also known as an encrypted electronic currency since its production and transfer are controlled by an encryption technique.

Blockchain is the central concept of the Bitcoin. In a Bitcoin system, a block would be generated approximately every ten minutes, where each block records all transactions in the world within ten minutes. Since each block includes an identification of its preceding block, it would be able to identify its preceding block. An initial block could be thus traced back from a current block, and an entire blockchain would be formed, where the blockchain records all transactions that have ever been executed. Whenever a block is added to the blockchain, each computer participating in the Bitcion transaction would be broadcast to have a copy. The probability of the blockchain being lost or collapsed would be minimized through such highly-distributed storage approach.

Since the operation of the Bitcoin is based on a distributed system without a central server, how to generate the aforesaid block is an important objective. The solution is to be implemented by a uniform proof of work (UPW) scheme. To be specific, each host in a network would input contents of a preceding block, transaction lists not appearing in any preceding block, and a random number into a hash function so as to calculate a hash value corresponding to the input. If the first n bits of the hash value calculated by any of the hosts satisfies a predetermined value, the aforesaid block is then generated, and the host which first finishes calculating the hash value would be a verifier of the block. The verifier would broadcast the block and the random number to the other hosts for verification. The process of generating a new block is referred to as “mining”. The speed of mining would be proportional to computational efficiency of a host. Hence, if there exists a host with high computational efficiency, the block verifier would be monopolized by such host, and double-spending would be potentially caused and thereby decrease the security level of the Bitcoin system.

### SUMMARY OF THE DISCLOSURE

Accordingly, the disclosure is directed to an electronic currency management method and an electronic currency system, where the possibility of double-spending by any apparatus would be greatly reduced, and the security of such distributed electronic currency system is enhanced.

The disclosure is directed to an electronic currency management method, adapted to a blockchain-based electronic currency network having multiple node apparatuses, where the node apparatuses include a first node apparatus. The electronic currency management method includes the following steps. First, consecutive preceding blocks in the blockchain are obtained by the first node apparatus. Next, the number of times that the first node apparatus in the electronic currency network has been elected as a block verifier of the preceding blocks is determined by the first node apparatus, and a difficulty level of the first node apparatus being elected as a block verifier of a next block is adjusted by the first node apparatus according to the elected times.

According to an exemplary embodiment, the difficulty level is proportional to an exponent or an exponential order of the elected times, where the exponential order of the elected times is a factorial of the elected times.

According to an exemplary embodiment, when the first node apparatus spends less time in calculating a verification value of a first block of the preceding blocks than other node apparatuses of the node apparatuses, the first node apparatus is elected as the block verifier of the first block.

According to an exemplary embodiment, the step of calculating the verification value of the first block includes to search for a random number such that particular bits of a hash value calculated based on the random number and a content of the first block equals to the verification value.

According to an exemplary embodiment, where the block verifier of each of the preceding blocks is the only one.

The disclosure is directed to an electronic currency system including multiple node apparatuses engaging in peer-to-peer communication with each other in an electronic currency network. Each of the node apparatuses stores a blockchain, and the node apparatuses include a first node apparatus. The first node apparatus obtains multiple consecutive preceding blocks in the blockchain, determines the number of times that it has been elected as a block verifier of the preceding blocks, and adjusts a difficulty level of itself being elected as a block verifier of a next block according to the elected times.

According to an exemplary embodiment, the difficulty level is proportional to an exponent or an exponential order of the elected times, where the exponential order of the elected times is a factorial of the elected times.

According to an exemplary embodiment, when the first node apparatus spends less time in calculating a verification value of a first block of the preceding blocks than other node apparatuses of the node apparatuses, the first node apparatus is elected as the block verifier of the first block.

According to an exemplary embodiment, each of the node apparatuses searches for a random number such that particular bits of a hash value calculated based on the random number and a content of the first block equals to the verification value.

According to an exemplary embodiment, where the block verifier of each of the preceding blocks is the only one.

In summary, in the electronic currency management method and the electronic currency system proposed in the disclosure, a difficulty level of each node apparatus in the electronic currency system being elected as a block verifier would be dynamically adjusted based on the elected times such that the difficulty level is exponentially proportional to the elected times. Accordingly, the block verifier would not be monopolized by a single node apparatus, and the potential of double-spending is thereby reduced.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A illustrates a schematic diagram of an electronic currency system in accordance with an exemplary embodiment of the disclosure.

FIG. 1B illustrates a block diagram of a node apparatus in an electronic currency system in accordance with an exemplary embodiment of the disclosure.

FIG. 2 illustrates a schematic diagram of a blockchain in an electronic currency system in accordance with an exemplary embodiment of the disclosure.

FIG. 3 illustrates a schematic diagram of an electronic currency management method in accordance with an exemplary embodiment of the disclosure.

FIG. 4 illustrates a flowchart of an electronic currency management method in accordance with an exemplary embodiment of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different foil is and should not be construed as limited to the embodiments set forth herein; rather, these embodiments are provided so that this disclosure will satisfy applicable legal requirements. Like reference numerals refer to like elements throughout.

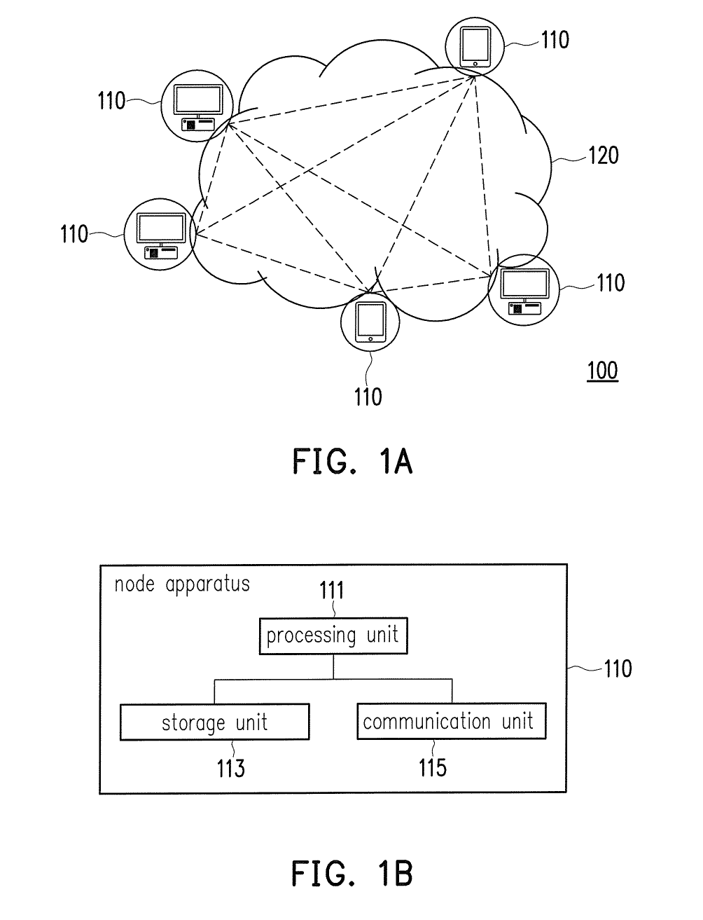

FIG. 1A illustrates a schematic diagram of an electronic currency system in accordance with an exemplary embodiment of the disclosure.

Referring to FIG. 1A, an electronic currency system 100 proposed in the disclosure includes an internet network 120 and a plurality of node apparatuses 110. The internet network 120 could be a wired or a wireless network. Each of the node apparatuses 110 could be an electronic device able to be wiredly or wirelessly connected to the internet network 120 such as a personal digital assistant (PDA), a smart phone, a tabular computer, a personal computer, and so forth. Each of the node apparatuses connected to the internet network 120 could engage peer-to-peer communication with each other.

FIG. 1B illustrates a block diagram of a node apparatus in an electronic currency system in accordance with an exemplary embodiment of the disclosure.

Referring to FIG. 1B, each of the node apparatuses 110 in the electronic currency system 100 could at least include a processing unit 111, a storage unit 113, and a communication unit 115. The processing unit 111 could be a central processing unit (CPU), a microprocessor, a digital signal processor (DSP), a programmable controller, application specific integrated circuits (ASIC), a programmable logic device (PLD), or other similar devices.

The storage unit 113 could be a random access memory (RAM), a read-only memory (ROM), a flash memory, a compact flash (CF), a memory card, a secure digital (SD) memory card, a micro SD memory card, a memory stick (MS), a hard disk drive (HDD), or other similar devices.

The communication unit 115 could be a wireless communication chip supporting wireless communication standards such as IEEE 802.11n/g/b, a network card supporting wired network communication (e.g. a high speed Ethernet card), a network chip, or other similar devices.

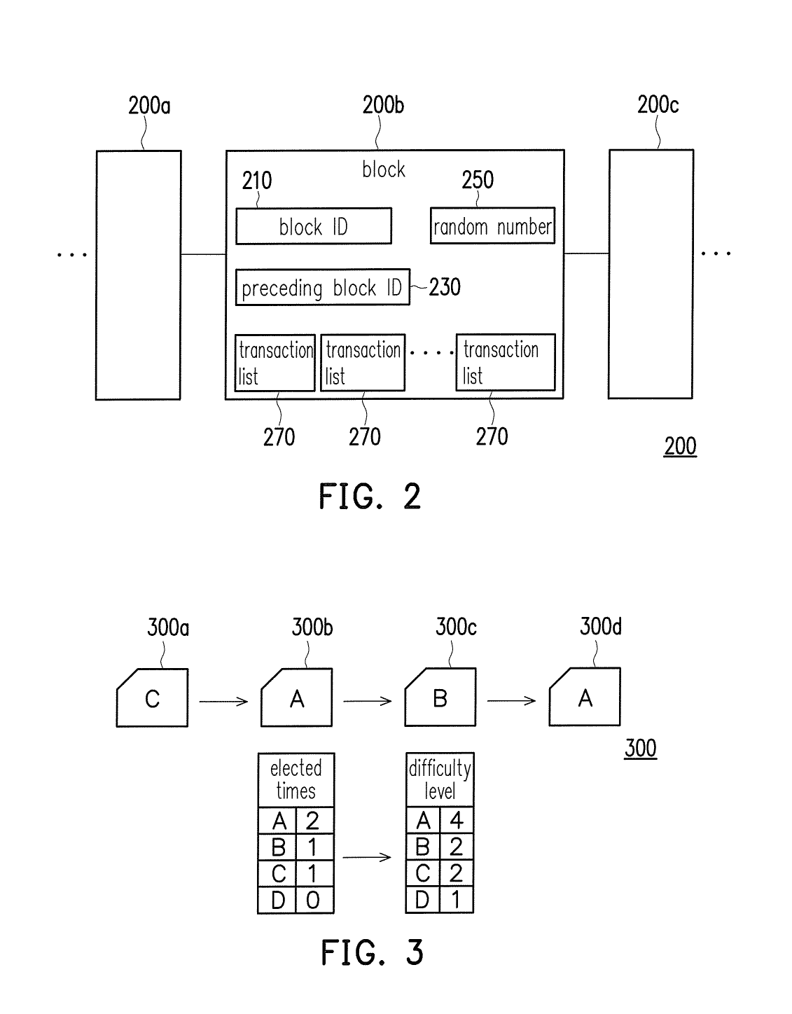

FIG. 2 illustrates a schematic diagram of a blockchain in an electronic currency system in accordance with an exemplary embodiment of the disclosure.

Referring to FIG. 2, a blockchain 200 in an electronic currency system in the disclosure may include a block 200a, a block 200b, a block 200c, and etc. Each of the blocks includes a block identification (ID) 210, a preceding block ID 230, a random number 250, and multiple transaction lists 270. Each of the blocks may identify its preceding block through its preceding block ID 230, and multiple blocks may thereby fon an integrated blockchain 200. For example, the block 200b may identify the block 200a as its preceding block through the preceding block ID 230, and the block 200c may identify the block 200b as its preceding block through the preceding block ID 230. It should be noted that the block ID 210 and the preceding block ID 230 of each of the blocks are stored as hash values.

All Bitcoin transactions are stored in the blockchain 200 formed by multiple blocks, where the blockchain 200 may be stored in the storage unit 113 of each of the node apparatuses 110. During mining, the processing unit 111 of each of the node apparatuses 110 would calculate a hash value of a content of a preceding block, receive multiple transaction lists broadcast from the interne network 120 via the communication unit 115, verify the validity of the transaction lists 270, and generate the random number 250 with no length restriction. Next, the processing unit 111 would input the hash value of the preceding block, the transaction lists 270 not appearing in any preceding block, and the random number 250 into a hash function (e.g. SHA 256) and obtain a binary value with a length of 256 bits. When an node apparatus among the node apparatuses 110 (referred to as “a first node apparatus” hereinafter) spends the least amount of time in calculating the binary value such that multiple particular bits of the aforesaid binary value (e.g. the first bits of the binary value being 0) is equal to the verification value, the first node apparatus would be elected as a block verifier of the new block and broadcast the new block along with the random value 250 to the other node apparatuses in the internet network 120. When any of the other node apparatuses receives the new block, it would add the new block into the blockchain 200 after the validity of the new block is verified.

Bitcoin uses a uniform proof of work (UPW) mechanism, where node apparatuses with high computational efficiency are able to solve a random number that satisfies certain requirements faster than other node apparatuses. In short, the probability of being a block verifier is proportional to the computational efficiency of a node apparatus. However, to prevent any node apparatus with high computational efficiency potentially from being monopolistic and thereby becoming an attacker in the system, the electronic currency system 100 uses a non-uniform and non-linear proof of work (NNPW) mechanism to adjust a difficulty level of each apparatus being elected as the block verifier.

In detail, FIG. 3 illustrates a flowchart of an electronic currency management method in accordance with an exemplary embodiment of the disclosure.

Referring to FIGS. 3, A, B, C, and D represent different node apparatuses 110 in the internet network 120. Assume that at the current time point, blocks 300a, 300b, 300c, and 300d are four newly-generated blocks in a blockchain 300. A block verifier of the block 300a is C; block verifiers of the blocks 300b and 300d are both A; a block verifier of the block 300c is B; D is not a block verifier of any of the blocks 300a-300d.

In the present exemplary embodiment, the storage unit 113 of each of the node apparatuses 110 stores a protocol (or referred to as a DiQi protocol) so that each of the node apparatuses 110 would have different difficulty levels in calculating for a random number and being a block verifier. To be specific, during mining, each of the node apparatuses 110 would input a hash value of a preceding block, transaction lists 270 not appearing in any preceding block, and a random number 250 into a hash function and obtain a binary value with a length of 256 bits. When any of the node apparatuses 110 spends the least amount of time in calculating the binary value such that multiple particular bits of the aforesaid binary value (e.g. the first bits of the binary value being 0), such node apparatus would be elected as a block verifier of the new block. In an exemplary embodiment, as the number of times of such particular node apparatus being elected as a block verifier of the preceding blocks reaches a predetermined number of times, the difficulty levels of the other node apparatuses of being elected as a block verifier would be dynamically adjusted.

For example, assume that the predetermined number of the preceding blocks is 4, and a difficulty level of being a block verifier may be obtained through the following equation: f(q)=p^{q}, where p is a constant. Assume that p=2, and q is the number of times of the node apparatuses A, B, C, and D being a block verifier of the preceding blocks. From the aforesaid equation, the number of times of node apparatuses A, B, C, and D being a block verifier are respectively 2, 1, 1, and 0. Hence, the difficulty levels of node apparatuses A, B, C, and D elected as a block verifier of a next block may be set to 4, 2, 2, and 1.

It should be noted that, after each difficulty level is set, the number of multiple particular bits of the aforesaid binary value would be dynamically adjusted by the DiQi protocol accordingly. For example, in terms of a node apparatus with a difficulty level of 1, it would require to search for a random number such that the first 10 bits of a binary value of the hashed random number are all 0 within the shortest time. In terms of a node apparatus with a difficulty level of 2, it would require to search for a random number such that the first 15 bits of a binary value of the hashed random number are all 0 within the shortest time. In terms of a node apparatus with a difficulty level of 4, it would require to search for a random number such that the first 20 bits of a binary value of the hashed random number are all 0 within the shortest time. In short, the difficulty level set in the DiQi protocol is proportional to the computational complexity to solve for the random number.

In another exemplary embodiment, each difficulty level of being a block verifier may be obtained through the following equation: f(q)=q^{!}, where q is the number of a corresponding node apparatus 110 of being as a block verifier in the predetermined number of the preceding blocks. From the aforesaid equation, the number of times of node apparatuses A, B, C, and D being a block verifier are respectively 2, 1, 1, and 0. Hence, the difficulty levels of node apparatuses A, B, C, and D elected as a block verifier of a next block may be set to 2, 1, 1, and 1. In another exemplary embodiment, a difficulty level of being a block verifier may be expressed as a function of f(q) satisfying f(0)=1, f′(q)>0, and f″(q)>0.

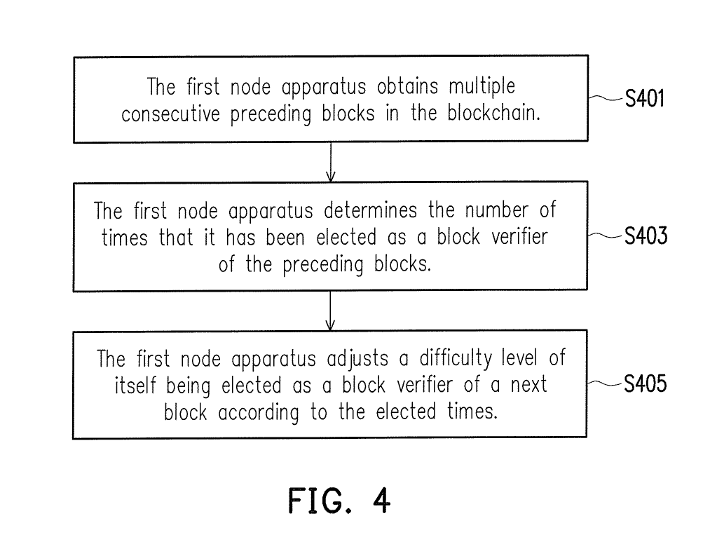

The proposed electronic currency management method may be summarized by a flowchart illustrated in FIG. 4 in accordance with an exemplary embodiment of the disclosure. The flowchart is adapted to each of the node apparatuses 110 in the electronic currency system 100. However, only one of the node apparatuses (referred to as “a first node apparatus”) would be illustrated for simplicity. All of the other node apparatuses could be deduced in a similar fashion.

Referring to FIG. 4, in Step S401, while the first node apparatus among the node apparatuses 110 is mining in the interne network 120, it would obtain multiple consecutive preceding blocks in a blockchain. In Step S403, the first node apparatus would determine the number of times that it has been elected as a block verifier of the preceding blocks. In Step S405, the first node apparatus would dynamically adjust a difficulty level of itself being elected as the block verifier of a next block according to the elected times. As the elected times increases, the difficultly would be increased exponentially accordingly.

In summary, in the electronic currency management method and the electronic currency system proposed in the disclosure, while node apparatuses are generating a new block or mining, each of them would dynamically adjust a difficulty level of itself being elected as a block verifier of the new block according to the number of times of being a block verifier of preceding blocks. Hence, even if there exists a node apparatus with high computational efficiency, the block verifier would not be monopolized by such node apparatus. The potential of double-spending is thereby reduced, and the security of such distributed electronic currency system is enhanced.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic currency management method, adapted to a blockchain-based electronic currency network having a plurality of node apparatuses, wherein the node apparatuses comprise a first node apparatus, and wherein the electronic currency management method comprises the following steps:
obtaining a plurality of consecutive preceding blocks in the blockchain by the first node apparatus;
determining the number of times that the first node apparatus has been elected as a block verifier of the preceding blocks by the first node apparatus; and
adjusting a difficulty level of the first node apparatus being elected as a block verifier of a next block by the first node apparatus according to the elected times.

2. The electronic currency management method according to claim 1, wherein the difficulty level is proportional to an exponent or an exponential order of the elected times, and wherein the exponential order of the elected times is a factorial of the elected times.

3. The electronic currency management method according to claim 1, wherein when the first node apparatus spends less time in calculating a verification value of a first block of the preceding blocks than other node apparatuses of the node apparatuses, the first node apparatus is elected as the block verifier of the first block.

4. The electronic currency management method according to claim 3, wherein the step of calculating the verification value of the first block comprises:
searching for a random number such that a plurality of particular bits of a hash value calculated based on the random number and a content of the first block equals to the verification value.

5. The electronic currency management method according to claim 1, wherein the block verifier of each of the preceding blocks is the only one.

6. An electronic currency management system comprising:
a plurality of node apparatuses, engaging in peer-to-peer communication with each other in an electronic currency network, wherein each of the node apparatuses stores a blockchain, wherein the node apparatuses comprise a first node apparatus, and wherein the first node apparatus obtains a plurality of consecutive preceding blocks in the blockchain, determines the number of times that the first node apparatus has been elected as a block verifier of the preceding blocks, and adjusts a difficulty level of the first node apparatus being elected as a block verifier of a next block according to the elected times.

7. The electronic currency management system according to claim 6, wherein the difficulty level is proportional to an exponent or an exponential order of the elected times, and wherein the exponential order of the elected times is a factorial of the elected times.

8. The electronic currency management system according to claim 6, wherein when the first node apparatus spends less time in calculating a verification value of a first block of the preceding blocks than other node apparatuses of the node apparatuses, the first node apparatus is elected as the block verifier of the first block.

9. The electronic currency management system according to claim 8, wherein each of the node apparatuses searches for a random number such that a plurality of particular bits of a hash value calculated based on the random number and a content of the first block equals to the verification value.

10. The electronic currency management system according to claim 6, wherein the block verifier of each of the preceding blocks is the only one.
